(19) United States
(12) Patent Application Publication
(10) Pub. No.: US 2005/0162411 A1
(43) Pub. Date: Jul. 28, 2005

(54) Input system

(76) Inventor: Cornelis Berkel van, Hove (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/516,847

(22) PCT Filed: Jun. 4, 2003
(86) PCT No.: PCT/IB03/02584

(30) Foreign Application Priority Data
Jun. 7, 2002 (GB) 0213237.1

(51) Int. Cl. G09G 5/00

(52) U.S. Cl. 345/179

(57) ABSTRACT

A user input system (1), comprising a coil (44) for generating an alternating magnetic field, a cordless pen (9), and a capacitive current measuring arrangement or an electric field sensing arrangement. The cordless pen (9) comprises a resonant circuit (34), a conductive housing (28) and a conducting tip (36). The alternating magnetic field induces an alternating voltage in the resonant circuit (34), which is coupled to the conducting tip (36). The capacitive current measuring arrangement comprises a resistive sheet (40) and current measuring means (42) arranged to measure a capacitive current flowing from the conducting tip (36) to the resistive sheet (40). The electric field sensing arrangement comprises an electric field sensing reception electrode (47) and current sensing circuitry (48) for determining a current excited in the electric field sensing reception electrode (47) by an electric field generated by the conducting tip (36). In each case the currents are sensed at plural locations and the differing magnitudes compared to determine a position of the conducting tip (36) relative to the plural locations. The system may also be adapted to sense a user's finger (8). The user input system (1) may be incorporated in a display device, for example an active matrix liquid crystal display device (4).

The present invention relates to user input systems, or user input devices, particularly those employing hand held pens or styluses. The present invention is particularly suited to, but not limited to, user input systems for display devices, e.g. liquid crystal display devices.

A wide variety of user input systems, devices or interfaces for equipment such as computers, vending machines, and so on, are known. Some types of input devices, e.g. conventional keyboards, are based on mechanically operated switches activated by a user's direct action of applying pressure, usually with a finger. Other types of input devices are based on sensing a user's action in some other way. For example, a conventional computer mouse senses the movement of the mouse caused by the user.

Many types of equipment also comprise, or in use are connected to, a display device or display screen. A known type of display device is a liquid crystal display device. Very often the information being displayed on the display device is updated as a user inputs data, such as an instruction or some other information into the equipment (e.g. information input via a computer keyboard is displayed on the computer monitor).

In some equipment the display device and the user input device are implemented in the form of an integrated display and user input device. Such devices are often referred to as “touchscreen” devices. In these cases, a user presses the display, or touches the display, directly or with an object, or places an object or e.g. a finger close to the display, at a desired location on the display area. The location on the display area often represents a choice of inputs displayed on the screen.

In other known input systems, such as disclosed for example by U.S. Pat. No. 4,878,533 and EP-0417921, a user selectively enters data by manipulating a pen or stylus in contact with or in proximity to the display. One type of system for implementing this comprises a loop or coil at the display arranged generate an alternating electromagnetic field to excite an induction circuit in the pen, the pen then itself generating an alternating electromagnetic field which is sensed by another loop or coil at the display (or the original loop or coil time multiplexed between emission and sensing). In other known systems in which the pen is sensed by virtue of generating an alternating electromagnetic field that is sensed by a loop or coil at the display, the pen has an internal power source rather than an induction circuit. One problem with these types of systems is the sensing loop or coil, and associated control electronics, may be difficult to implement in a display. Another disadvantage, depending on the intended application, is that a user's finger cannot be sensed to allow simultaneous or alternate touchscreen input.

U.S. Pat. No. 5,365,461 discloses an input system that senses both finger input and pen input. An alternating voltage source applies an alternating voltage to a resistive sheet, and capacitive coupling from the resistive sheet to either the user's finger or the pen is sensed. In the case of the user's finger, a path to ground is provided by the user, and the relative magnitude of currents flowing through each corner of the resistive sheet is measured and the results processed to determine the position of the finger. The pen is a conducting pen that is electrically connected to the alternating voltage source (hence the pen is physically tethered to the display i.e. corded) and during pen operation an alternating voltage is delivered to the pen such that current flows from the tip of the pen to the resistive sheet due to capacitive coupling therebetween. As with the finger operation, the relative magnitude of currents flowing through each corner of the resistive sheet is measured and the results processed to determine the position of the pen.

U.S. Pat. No. 5,777,607 discloses a similar system to that disclosed by U.S. Pat. No. 5,365,461, except that the pen is used as a voltage probe.

Another range of known sensing technologies includes capacitive sensing and electric field sensing, also known as quasi-electrostatic sensing, and which may be termed cross capacitive sensing. The use of electric field sensing to detect objects in 3-D space has been known for a long while, and is used for example in proximity sensors. In nature, the gnathomenu petersii fish uses electric field sensing to detect objects. In its very simplest form, capacitive sensing uses just one electrode and a measurement is made of the load capacitance of that electrode. This load capacitance is determined by the sum of all the capacitances between the electrode and all the grounded objects around the electrode. This is what is done in proximity sensing. Electric field sensing, which may be termed cross capacitance sensing, uses two electrodes, and effectively measures the specific capacitance between the two electrodes. The electrode to which electric field generating apparatus is connected may be considered to be an electric field sensing transmission electrode, and the electrode to which measuring apparatus is connected may be considered to be an electric field sensing reception electrode. The first (transmitting) electrode is excited by application of an alternating voltage. A displacement current is thereby induced in the second (receiving) electrode due to capacitive coupling between the electrodes (i.e. effect of electric field lines). If an object is placed near the electrodes (i.e. in the field lines) some of the field lines are terminated by the object and the capacitive current decreases. If the current is monitored, the presence of the object may be sensed.

U.S. Pat. No. 6,025,726 discloses use of an electric field sensing arrangement as, inter-alia, a user input device for computer and other applications. The electric field sensing arrangement senses the position of a user's finger(s), hand or whole body, depending on the intended application.

The present inventors have realised it would be desirable to provide a pen input system which is capable of being used alongside finger input, but where the pen is not connected to the display, i.e. where the pen is what may be termed a cordless pen. Preferably the system, in particular the sensing components thereof, would be convenient to implement in display devices, for example liquid crystal display devices. Preferably, input from a finger would be readily distinguished from input from such a pen.

In a first aspect, the present invention provides a user input system, comprising means for generating an alternating magnetic field (for example the magnetic field component of an alternating electromagnetic field), the generating means being for example a coil or loop; a user-holdable device comprising a resonant circuit; means for connecting to ground (earth); and a conducting tip; the means for connecting to ground being coupled to a first side of the resonant circuit and the conducting tip being coupled to a second side of the resonant circuit; the resonant circuit being operable to provide an alternating voltage induced from the alternating magnetic field when positioned in the vicinity of the means for generating an alternating magnetic field; and means for sensing an output provided at the conducting tip due to the alternating voltage source when the conducting tip is in the vicinity of the means for sensing an output.

Preferably the means for sensing an output provided by the conducting tip comprises means for determining the strength of the output as sensed at plural locations and means for comparing the plural sensed output strengths to determine a position of the conducting tip relative to the plural locations.

The sensing means may comprise a resistive sheet and current measuring means, e.g. an ammeter, arranged to measure a capacitive current flowing from the conducting tip to the resistive sheet.

Another possibility is that the sensing means comprises an electric field sensing reception electrode and current sensing circuitry for determining a current excited in the electric field sensing reception electrode by an electric field generated by the conducting tip.

The sensing means is preferably arranged to substantially filter out currents produced in the electric field sensing reception electrode by electric fields or electric field components generated by the means for generating an alternating magnetic field. The filtering out may be performed using a difference in phase between the electric field generated by the means for generating an alternating magnetic field compared to the electric field generated by the conducting tip. Additionally or alternatively, shielding may be provided to substantially block any electric field generated by the means for generating an alternating magnetic field and substantially allow to pass the magnetic field generated by the means for generating an alternating magnetic field. When the means for generating an alternating magnetic field is a coil or loop, the shielding preferably comprises a grounded toroidal wire wrapped around the coil.

The system may be arranged to determine the distance of the conducting tip from the plane of the electric field reception electrode, compare the determined distance to a predetermined threshold value, and if the determined value is less than or equal to the threshold then treat the conducting tip position as input and if the determined value is greater than the threshold then not treat the conducting tip position as input.

The user-holdable device is preferably constructed for use as a cordless pen or stylus, and the conducting tip is preferably adapted to provide a writing feel to the user.

Preferably the user-holdable device comprises an external housing by which the user is to hold the user-holdable device, and the housing is sufficiently conducting for the user's hand, when holding the cordless pen, to complete a connection from one side of the resonant circuit to earth. Another possibility is for a coupling coil to be positioned inside or outside the housing to facilitate coupling between the resonant circuit and the user's hand.

Preferably the system further comprises means for sensing a user's finger. When the sensing is performed by capacitive current sensing, capacitive current flow from the user's finger to the resistive sheet is sensed distinguishably from the current flowing due to the cordless pen. When the sensing is performed by electric field sensing, the electric field sensing electrodes are also used to sense a change in another generated electric field due to the user's finger interrupting this latter generated electric field.

In a further aspect, the present invention provides a display device, for example an active matrix liquid crystal display device, comprising a user input system according to any of the above described aspects. The plural current sensing locations may be located around the perimeter of a display area of the display device, preferably at each corner of a rectangular display area. The coil may be positioned around the perimeter of the display area. In the case of capacitive current sensing, a common or planar electrode of the display device may also be used as the resistive sheet of the capacitive current sensing arrangement.

In a further aspect, the present invention provides a user-holdable device, e.g. cordless pen or stylus, of any of the types described above with respect to the preceding aspects of the invention.

In a further aspect the present invention provides a set of user-holdable devices, comprising a plurality of user-holdable devices according to the previous aspect of the invention, wherein each user-holdable device has a different tuned frequency. By responding to differently generated frequencies of alternating magnetic field, the different pens may be distinguished by the input system, providing for example virtual input of different selected colours.

In a further aspect, the present invention provides a method of sensing user input using apparatus according to any of the aspects described above.

In further aspects, the present invention provides a user input system, comprising a coil for generating an alternating magnetic field, a cordless pen, and a capacitive current measuring arrangement or an electric field sensing arrangement. The cordless pen comprises an resonant circuit, a conductive housing and a conducting tip. The alternating magnetic field induces an alternating voltage in the resonant circuit, which is coupled to the conducting tip. The capacitive current measuring arrangement comprises a resistive sheet and current measuring means arranged to measure a capacitive current flowing from the conducting tip to the resistive sheet. The electric field sensing arrangement comprises an electric field sensing reception electrode and current sensing circuitry for determining a current excited in the electric field sensing reception electrode by an electric field generated by the conducting tip. In each case the currents are sensed at plural locations and the differing magnitudes compared to determine a position of the conducting tip relative to the plural locations. The system may also be adapted to sense a user's finger. The user input system may be incorporated in a display device, for example an active matrix liquid crystal display device.

Thus a cordless pen input system, that may also allow input from a user's finger, and that may readily be integrated into a display device such as a liquid crystal display device, is provided.

The above described and other aspects of this invention will be apparent from and elucidated with reference to the embodiments described hereinafter.

Embodiments of the present invention will now be described, by way of example, with reference to the accompanying drawings, in which:

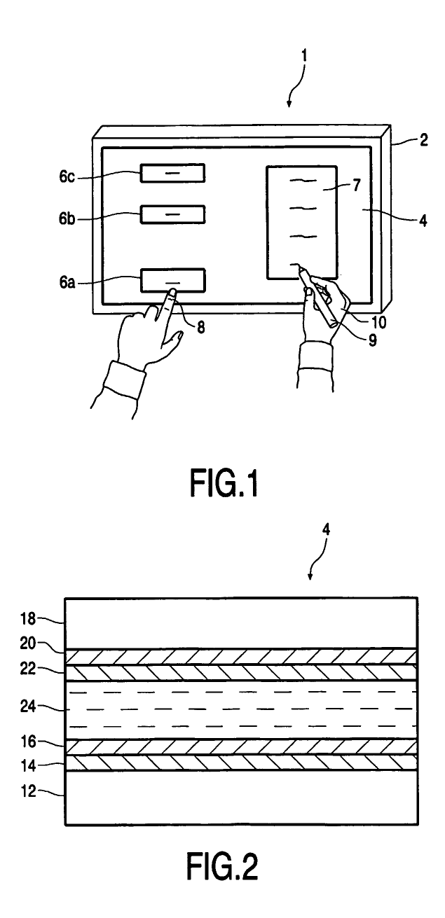

FIG. 1 is a schematic illustration (not to scale) of an integrated display and user input system;

FIG. 2 is a schematic cross-sectional view (not to scale) of a display screen;

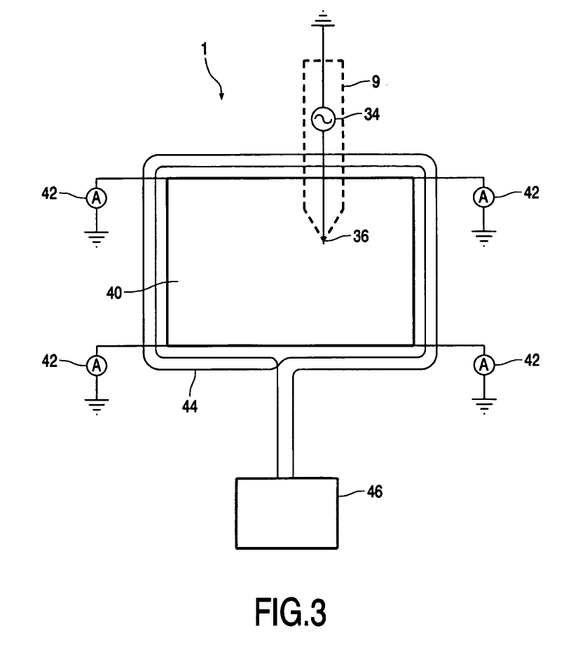

FIG. 3 is a schematic illustration of certain elements of the display and user input system of FIG. 1;

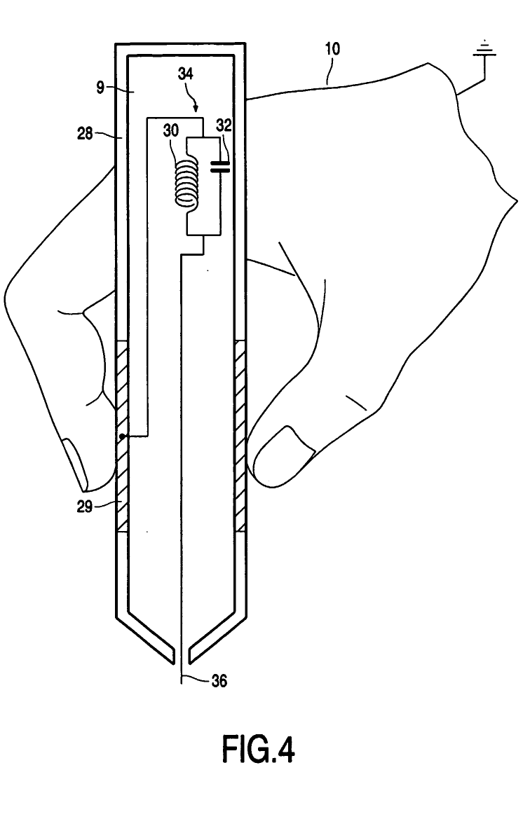

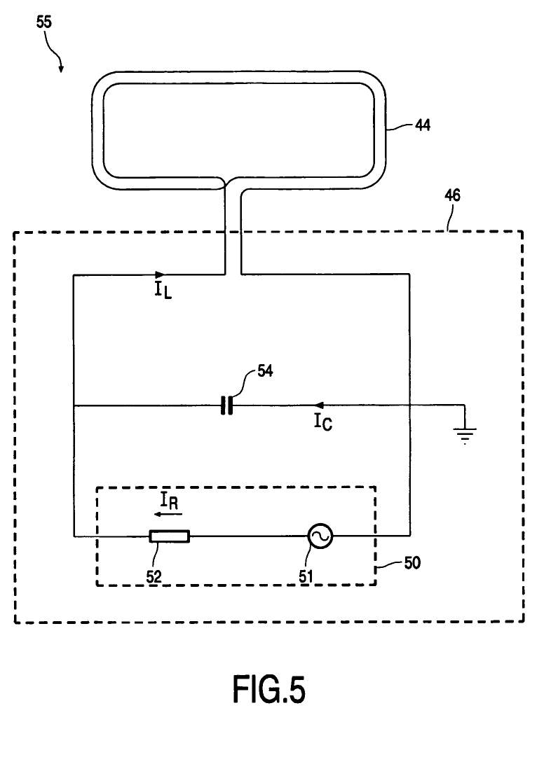

FIG. 4 is a schematic representation of a cordless pen being held in a user's right hand;

FIG. 5 is a schematic representation of a drive circuit connected to a coil;

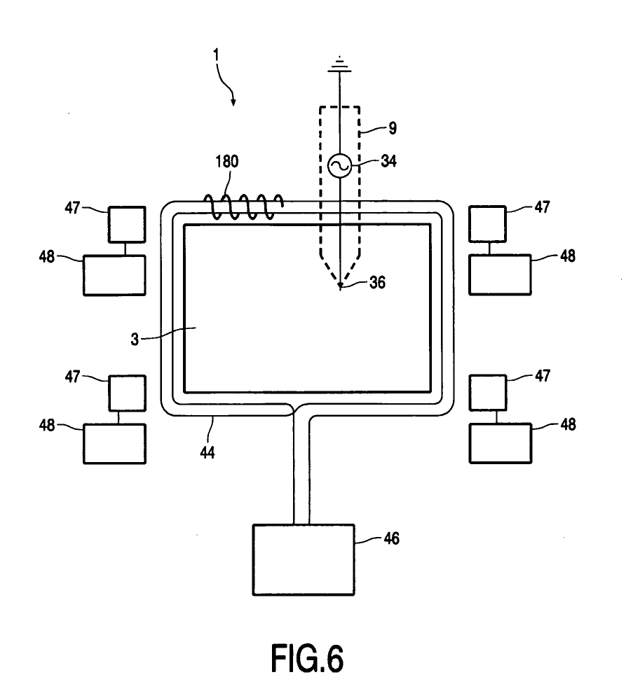

FIG. 6 is a schematic illustration of certain elements of another display and user input system;

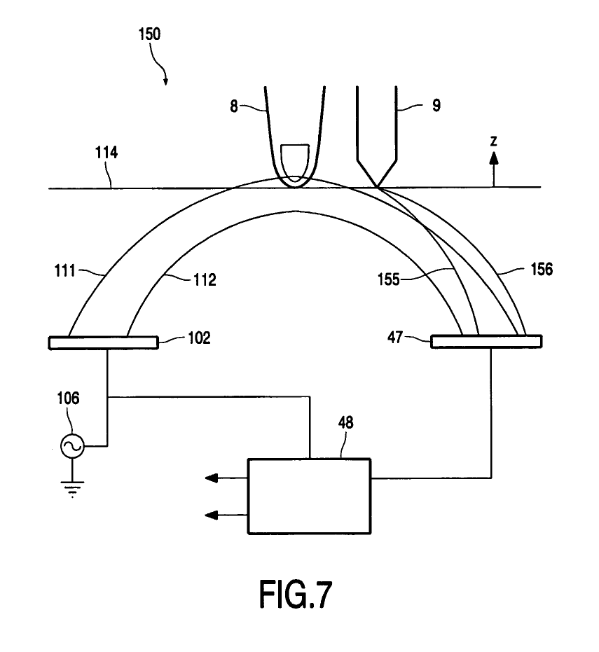

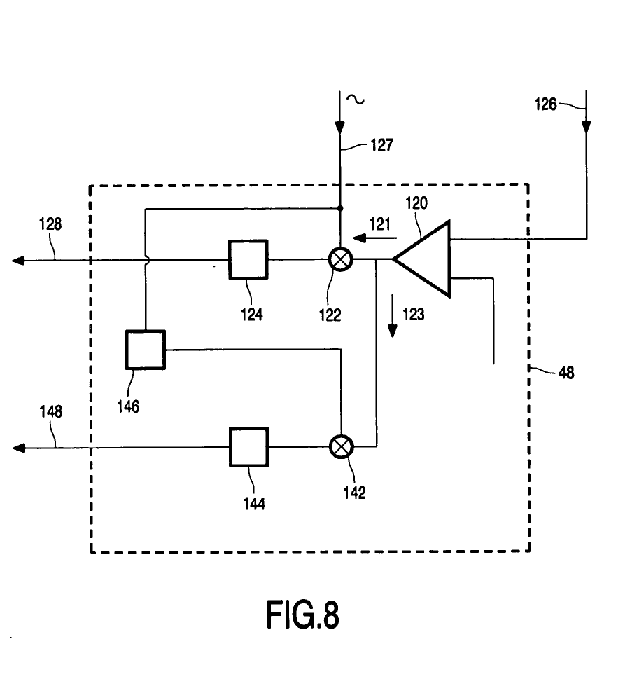

FIG. 7 is a schematic illustration of an electric field sensing arrangement of an electric field sensing reception electrode;

FIG. 8 is a block diagram showing functional modules of a current sensing circuit; and

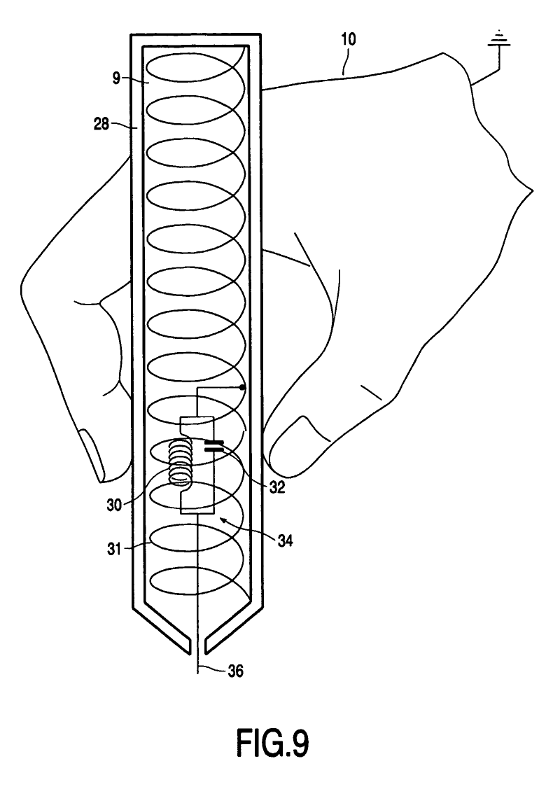

FIG. 9 is a schematic representation of another cordless pen.

The embodiments described below comprise integrated display and user input devices, i.e. touchscreen devices, in which input components, for providing an excitation electromagnetic field to a cordless pen and for sensing the cordless pen and a user's finger, are integrated in a display device. Nevertheless, it is to be appreciated that in other embodiments the same or corresponding input components may be provided without display device components, thereby providing a stand-alone input system separate from a display.

FIG. 1 is a schematic illustration (not to scale) of an integrated display and user input system 1, which may be referred to as a touchscreen device, according to the first embodiment. The system 1 comprises a housing 2, with a display screen 4.

On the display screen 4 is displayed an image comprising a plurality of icons representing virtual user buttons 6a, 6b, 6c. In this example one such user button, i.e. user button 6a, is shown being selected by a user placing the finger 8 of his left hand against the display screen within the area of the display screen at which the user button 6a is displayed.

The image also comprises a user writing area 7, which is an image representing an area where virtual writing, drawing or other patterning created by a user moving a pen or stylus over the area is displayed at the locations the user moves the pen. In this example such an input is being provided in response to a cordless pen 9 held in the user's right hand 10. The cordless pen 9 is an electronic/electromagnetic device, but is known as a pen, more specifically here a cordless pen, as it provides analogous operation to a traditional ink pen. It is also often referred to as a stylus.

FIG. 2 is a schematic cross-sectional view (not to scale) of the display screen 4. In this embodiment the display is a liquid crystal display. The display screen 4 comprises a first transparent plate (e.g. glass) 12 with an active matrix layer 14 disposed thereon. A liquid crystal orientation layer 16 is deposited over the active matrix layer 14. The display screen 4 further comprises a second transparent plate (e.g. glass) 18, with a common electrode layer 20 thereon, comprising a common electrode. The second transparent plate 18 has a liquid crystal orientation layer 22 deposited over the common electrode 20. The second transparent plate 18 is spaced apart from the first transparent plate 12. A liquid crystal layer 24, comprising twisted nematic liquid crystal material, is disposed between the orientation layers 14, 22 of the two transparent plates 12, 18. These and other details of the liquid crystal display device, except where otherwise stated below in relation to the additional inclusion of electric field sensing components, may be as per any conventional active matrix liquid crystal display device, and are in this particular embodiment the same as, and operate the same as, the liquid crystal display device disclosed in U.S. Pat. No. 5,130,829, the contents of which are contained herein by reference.

The active matrix layer 14 is formed from multiple thin film layers provided using conventional deposition and patterning techniques. The active matrix layer 14 comprises a plurality of display components. The term “display component” is used herein to refer to any item that contributes to the display functionality of the display screen 4. In this embodiment, the plural display elements include pixel electrodes, polysilicon thin film transistors (TFTs) (one for each pixel electrode), and driving lines, i.e. column and row driving lines.

In addition, the active matrix layer 14 comprises input components, for providing an excitation electromagnetic field to the cordless pen 9, and for sensing the cordless pen 9 and the user's finger 8, as will be explained in more detail below.

The common electrode is used, in conventional fashion, to provide a common voltage level at one side of the liquid crystal layer 24, as part of the liquid crystal light modulation (i.e. display) process. The common electrode layer 20 and indeed the display screen 4 as a whole thus further comprise conventional connections for providing the common electrode with the required voltage. However, in this embodiment, the common electrode is also used to sense capacitive currents from the cordless pen 9 and user's finger 8, as will be described in more detail below. Thus the common electrode layer 20, the active matrix layer 14, and indeed the display screen 4 as a whole further comprise suitable connections form the common electrode to the input components of the active matrix layer 14.

FIG. 3 is a schematic illustration of certain elements of the display and user input system 1. The system 1 further comprises a coil 44 (or loop) of conducting material. In this example, the coil 44 is formed from conducting tracks deposited on the first transparent plate 12 as part of the active matrix layer 14. In other embodiments the coil 44 may be implemented in any other suitable way, for example deposited on the second transparent plate, or in the form of copper wire cable. The coil 44 is coupled to a drive circuit 46.

The system 1 further comprises the cordless pen 9. The cordless pen 9 comprises a resonant circuit 34, which operates as an alternating voltage source, as will be described below. In operation the resonant circuit/effective voltage source 34 is coupled at one output to earth and at its other output to a conducting tip 36 that forms part of the cordless pen 9. The system 1 further comprises a resistive sheet 40 implemented in this example by the above mentioned common electrode, and substantially corresponding therefore in shape and area to a display area 3 of the display screen 4. The resistive sheet 40 is coupled at each corner through a respective ammeter 42 to earth.

The system 1 operates as follows. The drive circuit 46 drives the coil 44 such that the coil 44 generates an alternating magnetic field. The frequency of the alternating magnetic field is made substantially equal to the resonant frequency of the resonant circuit 34 of the cordless pen 9. The alternating magnetic field induces an alternating voltage across the resonant circuit 34, which in operation can therefore be considered as an alternating voltage source (as shown in FIG. 3).

A first side of the resonant circuit 34 is connected to the housing or some other structure of the cordless pen 9. The housing or other structure of the cordless pen is sufficiently conducting for the user's hand 10, when holding the cordless pen 9, to complete a connection from the first side of the resonant circuit 34 to earth (as will be explained in more detail below).

The second side of the resonant circuit 34 is connected to a conducting tip 36 of the cordless pen. When the tip 36 is placed on the resistive sheet 40, capacitive coupling between the tip 36 and the resistive sheet 40 causes a current to flow from the resonant circuit 34 through the pen tip 36 to the resistive sheet 40 and thus the ammeters 42. The relative magnitudes of the respective currents measured by each of the four ammeters 42 are processed, in conventional manner, to determine the position of the tip 36 relative to the corners of resistive sheet 40.

This embodiment further comprises an optional arrangement for additionally sensing the user's finger 8 when capacitively coupled to the resistive sheet 40. The arrangement comprises conventional capacitive coupling touchscreen circuitry connected to the resistive screen 40 via the four ammeters 42 such that a circuit to earth is completed when the user's finger 8 is capacitively coupled to the resistive sheet 40. As usual, the relative magnitudes of the respective currents measured by each of the four ammeters 42 are processed, in conventional manner, to determine the position of the tip 36 relative to the corners of resistive sheet 40. The currents measured in the ammeters 42 due to the user's finger 8 are distinguished from the currents measured in the ammeters 42 due to the cordless pen 9 in any suitable way. In this embodiment this is implemented by virtue of time multiplexing, i.e. the drive circuit 46 and the conventional capacitive coupling touchscreen circuitry operate alternately and the respective currents are measured at different times. In other embodiments, separate phases may be used and detected for the finger sensing compared to the pen sensing, or different frequencies of alternating voltage/current may be used.

The cordless pen 9 will now be described in more detail with reference to FIG. 4, which is a schematic representation of the cordless pen 9 being held in the user's right hand 10. The cordless pen 9 comprises a housing 28. The resonant circuit 34 comprises an inductor 30 in parallel with a capacitor 32.

Operation of the cordless pen 9 comprises the user's hand 10, when holding the cordless pen 9, completing a coupling from a first side of the resonant circuit 34 to ground. The structure, materials and connections of the cordless pen 9, including the housing 28, may be implemented as desired to provide such functionality. Also, preferably, the structure, materials and connections of the cordless pen 9 are arranged to minimise, or at any least reduce, shielding of the resonant circuit 34 from the magnetic field generated by the coil 44.

In this embodiment, the housing 28 is made of an insulating plastics material, except for a portion, here a band, of metal 29 toward the tip end of the pen, arranged for example as shown in FIG. 4. The band of metal 29 is located where a user will typically hold the cordless pen 9 in use. Thus, in use, effective coupling is provided between the resonant circuit 34 and the user's hand 10. As this conductive coupling between the user's hand 10 and the metal band 29 of the housing 28 is for alternating currents where capacitive coupling is dominant (for example 100 kHz frequency), it is possible if desired to include a thin insulating layer, e.g. paint, on the outside of the metal band 29 (and the rest of the housing 28, if desired, e.g. to provide a uniform surface appearance to the whole housing 28).

In this embodiment, the metal band 29 provides efficient coupling, yet shielding of the resonant circuit 34 from the magnetic field generated by the coil 44 is reduced compared to if the whole housing was of metal, and particularly so by virtue of the resonant circuit 34 (or at least the inductive part thereof being positioned in the cordless pen 9 at a location where it is surrounded by the insulating material part of the housing 28, i.e. located away from the metal part 29.

The second side of the resonant circuit 34 is connected to a conducting tip 36 that protrudes through a gap in the housing 28. The tip 36 is preferably structured to provide a suitable writing feel for the user when pressed against the outer surface of the display screen 2, whilst being sufficiently pointed or otherwise shaped at the end to allow for a suitable degree of capacitive coupling with the resistive sheet 40.

The drive circuit 46 will now be described in more detail with reference to FIG. 5, which is a schematic representation of the drive circuit 46 connected to the coil 44. In combination these provide an electromagnetic field generator 55 (i.e. magnetic field generator).

The drive circuit 46 comprises a function generator 50 which may be considered as an a.c. voltage source 51 in series with an internal resistance 52. A capacitor 54 is connected in parallel across the function generator 50. One end of the coil 44 is connected to one end of the capacitor 54 and function generator 50, and the other end of the coil 44 is connected to the other end of the capacitor 54 and function generator 50, and also to earth.

Although any suitable circuit may be used for driving the coil 44 with alternating current, this drive circuit arrangement is beneficial in that it provides relatively efficient transfer of energy from the function generator 50 to the coil 44. More particularly, with idealised components (e.g. zero resistance coil 44 and capacitor 54), at resonance a current I¹L flowing through the coil 44 would be 180° out of phase with a current I_{C} flowing through the capacitor 54, so that there would be zero current flowing through the internal resistance 52 of the function generator 50. Thus there would be no voltage dropped across the internal resistance 52, i.e. the voltage across the coil 44 would be maximised. However, in practice there are real resistances associated with the coil 44 and the capacitor 54 over which some voltage will be dropped.

In the above described embodiment, the common electrode of the liquid crystal display device is used as the resistive sheet 40. This is made possible by virtue of the second transparent plate 18 being made sufficiently thin that sufficient capacitive coupling occurs between the user's finger 10 and the cordless pen 9 when these are placed against or near to the outer surface of the second transparent plate 18. In other embodiments, a separate resistive sheet may be provided in addition to the common electrode, i.e. as is the usual approach in conventional capacitive touchscreen devices. Another possibility is that the resistive sheet may be deposited as a transparent conductive layer on the outside surface of the second transparent plate 18. These possibilities apply also to the coil 44.

In the above described first main embodiment, the position of the cordless pen 9 (and optionally the user's finger 8) is sensed by means of currents provided by capacitive coupling. In a second main embodiment, described below with reference to FIGS. 6 to 8, the position of the cordless pen 9 (and optionally the user's finger 8) is sensed using electric field sensing.

FIG. 6 is a schematic illustration of certain elements of the display and user input system 1 of this second embodiment. The system 1 comprises the following items arranged in the same manner as in the case of the first embodiment: a coil 44 (or loop) of conducting material, a drive circuit 46, and a cordless pen 9.

However, in this second embodiment, there is no resistive sheet with ammeters connected thereto. Instead, electric field sensing components are positioned near to each corner of a display area 3 of the display screen 4. More particularly, a respective electric field sensing electrode 47 is positioned at each corner of the display area 3, with each electric field sensing electrode 47 being coupled to a respective current sensing circuit 48. In this embodiment the electric field sensing components are formed as part of the active matrix layer 14, but generally they may be provided at any convenient place within the structure of the display screen 4.

In this embodiment, the drive circuit 46 and coil 44 are operated in the same way as in the first embodiment, such that the resonant circuit operates as an alternating voltage source.

In this embodiment, an alternating voltage provided by the resonant circuit 34 (operating as an alternating voltage source) generates an alternating electric field from the tip 36 of the cordless pen 9. When the tip 36 is placed on or near the display area 3, this electric field excites the electric field sensing electrodes 47 thus causing currents to flow which are sensed or measured by the respective current sensing circuits 48. The relative magnitudes of the respective currents sensed or measured by each of the four current sensing circuits 48 are processed in conventional manner to determine the position of the tip 36 relative to the corners of the display area 3.

The current sensing circuits 48 may be implemented in any suitable way. In this embodiment they are implemented in a way that is particularly suited to a further optional arrangement included in this embodiment, namely an arrangement for also sensing the user's finger 8 when it is positioned near to the display screen 4. This will be further described with reference to FIGS. 7 and 8.

FIG. 7 is a schematic illustration of the electric field sensing arrangement of one of the electric field sensing reception electrodes 47. One (or more) further electrodes is provided as an electric field sensing transmission electrode 102 (note this is used here for the finger sensing, it would not be required for just detection of the cordless pen 9). The electric field sensing transmission electrode(s) 102 may be positioned at any suitable location, e.g. around the display area 3, or may be provided by time-multiplexing the other electric field sensing reception electrodes 47 and switching their use to transmission. In this embodiment separate transmission electrodes are formed as part of the active matrix layer 14. The sensing arrangement further comprises the current sensing circuit 48 connected to the electric field sensing reception electrode 47, and an alternating voltage source 106 connected to the electric field sensing transmission electrode 102.

We shall first consider the operation of the arrangement when the cordless pen 9 is not in the vicinity of the display screen 4, i.e. we first consider the detection of just the user's finger 8.

In operation, when an alternating voltage is applied to the electric field sensing transmission electrode 102, electric field lines are generated, of which exemplary electric field lines 111 and 112 pass through the electric field sensing reception electrode 47. The field lines 111, 112 induce a small alternating current which is measured by the current sensing circuit 48 (the current sensing circuit 48 uses a tapped off signal from the alternating voltage to tie in with the phase of the electric field induced current, as will be described in more detail below).

Also shown in FIG. 7 is the position of the outer surface 114 of the display screen 4. When the user's finger 8 is placed against the outer surface 114 of the display screen 4 (or near the surface even if not touching as such) the finger 8 terminates those field lines (in the situation shown in FIG. 7, the field line 111) that would otherwise pass through the space occupied by the finger 8, thus reducing the current flowing from the electric field sensing reception electrode 47. Thus the current level measured by the current sensing circuit is used as a measure of the presence of a finger 8 in the vicinity of the electric field sensing reception electrode 47.

FIG. 8 is a block diagram showing functional modules of the current sensing circuit 48. The current sensing circuit 48 comprises an amplifier 120 whose input is connected to the electric field sensing electrode 47. The output from the amplifier 120 splits in to two, providing two effective processing channels. One of these processing channels (hereinafter referred to as the first processing channel 121) is for processing changes to the currents provided by the field lines (e.g. 111, 112) generated by the electric field sensing transmission electrode 102 (i.e. for sensing of the user's finger 8). The other processing channel (hereinafter referred to as the second processing channel 123) is for processing currents provided by the electric field generated by the cordless pen 9 (i.e. for sensing the cordless pen 9).

The first processing channel 121 comprises a multiplier 122 and a low-pass filter 124. These functional modules (and those described below for the second processing channel 123) may be implemented in any suitable form, for example using the circuit design disclosed in U.S. Pat. No. 6,025,726, the contents of which are contained herein by reference.

The first processing channel 121 operates as follows. The displacement current 126 induced in the electric field sensing reception electrode 47 is amplified by the amplifier 120 and multiplied by the multiplier 122 with a tapped-off and phase shifted (by a phase shift module that is not shown) version 127 of the voltage applied to the electric field sensing transmitting electrode 102. The tapped-off voltage is phase shifted so as to render the phase the same as that of the displacement current 126. Thus, if we assume here that the amplifier 120 is ideal, i.e. does not introduce any additional phase shifts to the displacement current 126, then the phase of the tapped-off voltage is shifted 90°. If, in practise, the amplifier 120 does introduce additional phase shifts to the displacement current 126, then the phase of the tapped-off voltage is adjusted as required to accommodate this.

The output from the multiplier 122 is then low-pass filtered to provide an output signal 128. The output signal 128 is thus a measure of the current induced in the electric field sensing reception electrode 47 by the electric field generated by the electric field sensing transmission electrode 102, and will vary in response to the finger 8 being placed in the vicinity of the electric field sensing electrodes 102, 47. The output signal 128 is then processed along with the corresponding outputs from the other three electric field sensing arrangements (i.e. at the other three corners) to determine the position of the finger 10 according to the relative magnitudes of the respective currents determined by each of the four electric field sensing arrangements.

We shall now consider the operation of the arrangement in respect of sensing the cordless pen 9 when it is in the vicinity of the display screen 4. Referring again to FIGS. 6 and 7, as described above, the drive circuit 46 drives the coil 44 such that the coil 44 generates an alternating magnetic field. The frequency of the alternating magnetic field is made substantially equal to the resonant frequency of the resonant circuit 34 of the cordless pen 9. The alternating magnetic field induces an alternating voltage across the resonant circuit 34, which in operation can therefore be considered as an alternating voltage source. The resonant circuit 34 operating as an alternating voltage source generates an electric field, represented in FIG. 7 by field lines 155, 156. When the cordless pen 9 is placed against, or near, the outer surface 114 of the display screen 4, in the vicinity of the electric field sensing reception electrode 47, the field lines 155, 156 generated by the cordless pen 9 pass through the electric field sensing reception electrode 47. The field lines 155, 156 thus induce a further small alternating current that is also measured by the current sensing circuit 48, as will now be described with reference again to FIG. 8.

In particular, the second processing channel 123 of the current sensing circuit 48 is used for processing the alternating current induced by the electric field 155, 156, and will now be described. The second processing channel 123 comprises a second multiplier 142, a second low-pass filter 144, and a phase shift module 146. These functional modules may again be implemented in any suitable form. As described above, in operation, the displacement current 126 induced in the electric field sensing reception electrode 47 is amplified by the amplifier module 120, and the amplified output from the amplifier module 120 is split and passed to multiplier 142 (as well as multiplier 122).

The tapped-off and 90° phase shifted version 127 of the voltage applied to the electric field sensing transmitting electrode 102 is also fed to the phase shift module 146, and the phase shift module applies a 90° phase shift. The multiplier 142 multiplies the amplified current signal with the resulting version of the tapped-off voltage, and the resulting multiplied signal is then low-pass filtered by the low-pass filter 144 to provide a second output signal 148. This second output signal 148 is thus a measure of the current induced in the electric field sensing reception electrode 47 by the electric field 155, 156 generated at the conducting tip 36 of the cordless pen 9, and will vary according to the position of the conducting tip 36 relative to the electric field sensing reception electrode 47.

The output signal 148 is then processed along with the corresponding outputs from the other three electric field sensing arrangements (i.e. at the other three corners) to determine the position of the cordless pen 9 according to the relative magnitudes of the respective currents determined by each of the four electric field sensing arrangements.

In the circuit shown in FIG. 4, two processing channels are formed, the first channel 121 comprising the first multiplier 122 and the first low-pass filter 124, the second channel 123 comprising the second multiplier 142 and the second low-pass filter 144. As an alternative to two such processing channels, a single processing channel may be employed in time multiplexed fashion, by switching the phase reference input between a 0° phase and a 90° phase.

In this embodiment, the alternating voltage provided by the resonant circuit 34 is (ideally) 90° out of phase with the voltage across the coil 44. This means that the currents produced in the electric field sensing reception electrodes 47 by the electric field generated by the coil 44 (a potential form of interference) are effectively (or at least substantially) filtered out by the current sensing circuits 48, i.e. the “in phase” first channel 121 measures the displacement current coupled from the coil 44, while the “out of phase” second channel 123 measures the displacement current from the cordless pen 9.

Other approaches may be employed instead of, or in addition to, effectively filtering out the currents produced in the electric field sensing reception electrodes 47 by the electric field generated by the coil 44 (as discussed in the preceding paragraph). One possibility is to turn the coil 44 off periodically and to measure the currents from the electric field sensing reception electrodes 47 when the coil is turned off. This is readily implemented, as the signal from the coil 44 will ring down, i.e. fall away, much quicker than that from the cordless pen 9. This is because when the coil is turned off, both ends are grounded, so there is no voltage difference across them to produce a signal. Referring back to FIG. 6, another possibility, which is employed as a preferred option in this embodiment, is to provide a grounded toroidal wire 180 around the coil 44 (for clarity, only a portion of the coil 44 is shown with the toroidal wire 180 in the Figure, but in practice this will extend along the whole length of the coil 44). The toroidal wire 180 substantially shields the electric field generated by the coil 44, but does not significantly affect the magnetic field generated by the coil 44 since any edicurrents will be in a direction away from the centre of the toroid.

The drive circuit 46 and the current sensing circuits 48 are adapted so that the signals detected from the cordless pen 9 are not too low to be detected at the maximum required operating distance of the pen away from the display screen 4. Likewise the drive circuit 46 and the current sensing circuits 48 are adapted so that the signals detected from the cordless pen 9 are not saturated when the cordless pen 9 is touching the display screen 4. This is preferably implemented by means of a dynamic adjustment arrangement, in which a feedback route is provided between the current sensing circuits 48 and the drive circuit 46, such that the voltage applied to the coil 44 is reduced as the currents sensed by the current sensing circuits 48 increase.

Another preferred option implemented in this embodiment is as follows. The distance of the tip 36 of the cordless pen 9 away from the plane of the electric field reception electrodes 47 (i.e. the “altitude” or z-axis 9 as shown in FIG. 7) distance if the display plane is defined by an x-axis and a y-axis) is determined from the relative currents of the electrodes in conventional manner. The determined distance is compared to a predetermined threshold value. If the determined value is less than or equal to the threshold, then the cordless pen 9 is considered to be being used for writing by the user, and the determined x-y position is used as user input. However, if the determined value is greater than the threshold, then it is considered that the cordless pen 9 is not intended to be used by the user for writing at that moment, i.e. the system operates on the basis that the user has removed the cordless pen 9 from the virtual writing surface, and the x-y position of the cordless pen 9 is not treated as user input. The threshold may be determined in any suitable manner, including use of algorithms to enable the system to be adapted to individual users' ways of operating the system, for example by using a standard training schedule whereby the system monitors a user's implementation of a set writing task and adapts the threshold accordingly. Alternatively or additionally the threshold may be reset or otherwise varied by direct user choice.

In the above embodiments, the coupling between the user's hand 10 (and hence to earth) and the resonant circuit 34 is made via a conducting part 29 of the housing 28 of the cordless pen 29 as described with reference to FIG. 4. However, such coupling may be made in any manner that provides a required degree of coupling. For example, the housing 28 may be provided in any suitable combination of conducting and insulating material that provided the required amount of coupling. Other arrangements may also be employed. One preferred arrangement will now be described with reference to FIG. 9.

FIG. 9 shows another preferred arrangement of the cordless pen 9. The cordless pen 9 comprises the following same components as described earlier: the housing 28, the resonant circuit 34, comprising the inductor 30 and the capacitor 32, the conducting tip 36. In this arrangement the housing 28 is made of insulating plastic. The cordless pen 9 further comprises a coupling coil 31, arranged to lie close to the inner surface of the housing 28, along substantially the length of the cordless pen 9, thereby surrounding the resonant circuit 34 (the coupling coil 31 may alternatively be arranged around the outside of the housing 28). The coupling coil 31 is connected to the first side of the resonant circuit 34. The conducting tip 36 is connected to the second side of the resonant circuit 34. The coupling coil serves to capacitively couple the alternating currents provided by the resonant circuit 34 with the user's hand 10. The plastic material of the housing 28 represents the dielectric of a capacitor formed between the coupling coil 31 and the user's hand 10. A preferred frequency to achieve such an effect is for example 100 kHz. By extending the length of the cordless pen 9, the coupling coil 31 maximises the coupling effect with the user's hand 10. The coupling coil is arranged to minimise or reduce eddy currents, and therefore absorption of magnetic flux of the magnetic field generated by the coil 44. This preserves or at least does not too significantly diminish the efficiency with which the magnetic field reaches resonant circuit 34. Nevertheless, as another possibility, the coupling coil may be arranged to extend over only some of the length of the cordless pen 9, and may for example be arranged so that it does not surround or extend along the resonant circuit 34.

In the above embodiments, it is preferable that the resonant circuit 34 is tuned accurately to the frequency at which the coil 44 is driven. For this reason, it is preferable that the capacitor 32 is implemented as a thermally stable capacitor. For example, capacitor 32 may be implemented using two capacitors in parallel, namely a polystyrene capacitor with a thermal drift rate of 0.01% per ° C. and a 6-50 pF ceramic capacitor with a thermal drift rate of 0.03% per ° C.

In the above embodiments, the resonant circuit 34 comprises an inductor and a capacitor in parallel. However, other inductor/capacitor based circuits may be used to provide the resonant circuit, providing a means for causing induction from the magnetic field is provided along with storage means to store the energy thereby provided.

In the above described embodiments, the position of the cordless pen 9 relative to the four corners is determined from the relative currents measured at the four corners. Optionally, the total magnitudes of the currents from the four corners may be determined and used to determine the tilt angle of the cordless pen relative to the display screen 4, since the total current is a function of the strength of the magnetic induction between the coil 44 and the inductor 30 of the cordless pen 9. Determining the tilt angle of the cordless pen 9 is useful because the system can optionally be arranged to use this information to correct for parallax. This is an effect that arises because the a limit to how close the conducting tip of the cordless can be to the actual image plane is determined by the thickness of the top transparent plate 18 of the display panel. The system is arranged to determine the x.y position of the pen tip, however the user will perceive the tip to be at a position x+delta_x, y+delta_y, which is determined by the angle at which he looks at the pen (zero degrees to the normal will mean delta=0 and increasing angle to the normal will mean increasing deltas). The system is arranged to use the angle at which the pen is held to estimate whether the pen is being held in the left or right hand and/or also make (based on writing style) estimates or calculations as to the angle at which the user is likely to be viewing the pen. The system may be arranged to make adjustments based on these results.

In all the above embodiments, further features employed in conventional electromagnetic pen sensing arrangements may be employed where appropriate. For example, multiple cordless pens with different respective tuned frequencies may be employed, to provide e.g. colour distinction. Another possibility is that the tuning frequency may be varied with the pressure applied in pressing the pen against the surface of the display, and processed to lead, for example, to display of different thickness lines in response thereto (the tip of the cordless pen is sprung, and as the pen is pressed against the surface, the sprung tip moves a ferrite stud into the inductor coil, hence changing its inductance value and hence the tuning frequency.

In the above embodiments the cordless pen 9 is shaped like a conventional pen, to assist the user with virtual writing. However, other shapes may be employed, and the item may in fact be used for input actions not usually considered to be associated with a conventional ink pen as such. For example, the item may be used as a token or tag, and may be used for an input process where the user is merely required to position the item at or near a particular area of the display to select a particular choice offered on the display.

In the above embodiments the cordless pen 9 comprises the resonant circuit 34. However, in other embodiments, any other suitable type of induction circuit may be used, and such circuits need not necessarily be tuned or resonant. More generally, the resonant circuit 34 may be replaced by any circuit or other means that functions to allow a voltage to be provided as a result of induction of the magnetic field generated by the coil 44.

In the above embodiments the coil 44 is formed by the conducting material running round the perimeter of the resistive sheet 40/display area 4 one or more times (in FIGS. 3 and 6, for clarity, the conducting material is shown looped round twice). One preferred choice is for the material to be looped round five times. The number of times wound round and the conducting material employed are design choices that may be varied as suits. Also, the coil 44 may be positioned anywhere convenient around the perimeter of the resistive sheet 40/display area 4, including spaced apart somewhat from the perimeter of the resistive sheet 40/display area 4, and/or without following the shape of the perimeter of the resistive sheet 40/display area 4, and/or including some parts thereof lying over some part of the resistive sheet 40/display area 4.

Although the above embodiments implement the user input system in conjunction with a liquid crystal display device, it will be appreciated that these embodiments are by way of example only, and the invention may alternatively be implemented in conjunction with any other suitable form of display device allowing input systems such as those described above to be incorporated or otherwise accommodated. Such display devices include, for example, plasma, polymer light emitting diode, organic light emitting diode, field emission and switching mirror display devices.

From reading the present disclosure, other variations and modifications will be apparent to persons skilled in the art. Such variations and modifications may involve equivalent and other features which are already known in the art, and which may be used instead of or in addition to features already described herein.

1. A user input system, comprising:
means for generating an alternating magnetic field;
a user-holdable device comprising a resonant circuit, means for coupling to ground, and a conducting tip, the means for coupling to ground being coupled to a first side of the resonant circuit (34)and the conducting tip being coupled to a second side of the resonant circuit, the resonant circuit being operable to provide an alternating voltage induced from the alternating magnetic field when positioned in the vicinity of the means for generating an alternating magnetic field; and
means for sensing an output provided at the conducting tip due to the alternating voltage source when the conducting tip is in the vicinity of the means for sensing an output.

2. A system according to claim 1, wherein the means for sensing an output provided by the conducting tip comprises means for determining the strength of the output as sensed at plural locations and means for comparing the plural sensed output strengths to determine a position of the conducting tip relative to the plural locations.

3. A system according to claim 1, wherein the sensing means comprises a resistive sheet and current measuring means arranged to measure a capacitive current flowing from the conducting tip to the resistive sheet.

4. A system according to claim 1, wherein the sensing means comprises an electric field sensing reception electrode and current sensing circuitry for determining a current excited in the electric field sensing reception electrode by an electric field generated by the conducting tip.

5. A system according to claim 4, wherein the sensing means is arranged to substantially filter out currents produced in the electric field sensing reception electrode by electric fields generated by the means for generating an alternating magnetic field.

6. A system according to claim 5, wherein the filtering out is performed using a difference in phase between the electric field generated by the means for generating an alternating magnetic field and the electric field generated by the conducting tip.

7. A system according to claim 1, wherein shielding is provided to substantially block any electric field generated by the means for generating an alternating magnetic field and substantially allow to pass the magnetic field generated by the means for generating an alternating magnetic field.

8. A system according to claim 4, arranged to determine the distance of the conducting tip from the plane of the electric field reception electrode, compare the determined distance to a predetermined threshold value, and if the determined value is less than or equal to the threshold then treat the conducting tip position as input and if the determined value is greater than the threshold then not treat the conducting tip position as input.

9. A system according to claim 1, wherein the user-holdable device is for use as a pen or stylus.

10. A system according to claim 9, wherein the conducting tip is adapted to provide a writing feel to the user.

11. A system according to claim 1, wherein the user-holdable device comprises an external housing by which the user is to hold the user-holdable device, and wherein the means for coupling to ground is such that the coupling to ground is made via the user's hand when the user is holding the user-holdable device.

12. A system according to claim 11, wherein the means for coupling to ground is further arranged to reduce shielding of the resonant circuit from the magnetic field generated by the means for generating an alternating magnetic field.

13. A system according to claim 11, wherein the means for coupling to ground comprises at least a portion of the housing being coupled to the first side of the resonant circuit and being sufficiently conducting for the coupling to ground via the user's hand.

14. A system according to claim 13, wherein the resonant circuit is positioned in the user-holdable device at a location away from the conducting portion of the housing.

15. A system according to claim 12, wherein the user-holdable device further comprises a coil arranged to couple the resonant circuit to the user's hand whilst substantially allowing the magnetic field generated by the means for generating an alternating magnetic field to reach the resonant circuit.

16. A system according to claim 1, further comprising means for sensing a user's fingers.

17. A system according to claim 16, when dependent from claim 3, wherein the means for sensing the user's finger comprises the resistive sheet, the current measuring means, and means for distinguishing between sensing of the user's finger and sensing of the user-holdable device.

18. A system according to claim 16, when dependent from claim 4, wherein the means for sensing a user's finger comprises an electric field sensing transmission electrode, the electric field sensing reception electrode, and circuitry for sensing changes caused by the user's finger to a current excited in the electric field sensing reception electrode by an electric field generated by the electric field sensing transmission electrode.

19. A system according to claim 1, further comprising one or more further user-holdable devices, respective user-holdable devices having different tuned frequencies.

20. A display device comprising a user input system according to claim 1.

21. A display device according to claim 20, wherein the sensing means is arranged to sense the output provided by the conducting tip in an area corresponding to a display area of the display device.

22. A display device according to claim 20, wherein the display device is an active matrix liquid crystal display device.

23. A display device according to claim 20, when the user input system is according to claim 3, or claim 9 when dependent from claim 3, wherein the resistive sheet is provided by a common electrode of the display device.

24. A user-holdable device for a user to provide input to a user input system, comprising:
a resonant circuits;
means for coupling to ground; and
a conducting tip;
the means for coupling to ground being coupled to a first side of the resonant circuit and the conducting tip being coupled to a second side of the resonant circuit, the resonant circuit being operable to provide an alternating voltage induced from an alternating magnetic field.

25. A device according to claim 24, for use as a pen or stylus.

26. A device according to claim 25, wherein the conducting tip is adapted to provide a writing feel to the user.

27. A device according to claim 24, comprising an external housing by which the user is to hold the user-holdable device, and wherein the means for coupling to ground is such that the coupling to ground is made via the user's hand when the user is holding the user-holdable device.

28. A device according to claim 27, wherein the means for coupling to ground is further arranged to reduce shielding of the resonant circuit from the magnetic field generated by the means for generating an alternating magnetic field.

29. A device according to claim 27, wherein the means for coupling to ground comprises at least a portion of the housing being coupled to the first side of the resonant circuit and being sufficiently conducting for the coupling to ground via the user's hand.

30. A device according to claim 29, wherein the resonant circuit is positioned in the user-holdable device at a location away from the conducting portion of the housing.

31. A device according to claim 28, wherein the user-holdable device further comprises a coil arranged to couple the resonant circuit to the user's hand whilst substantially allowing magnetic fields to reach the resonant circuit.

32. A set of user-holdable devices, comprising a plurality of user-holdable devices according to claim 24, wherein each user-holdable device has a different tuned frequency.

33. A method of sensing user input from a user-held devices, comprising:
generating an alternating magnetic field that passes in to the user-held object;
inducing an alternating voltage in the user-held object from the alternating magnetic field;
providing an output from the alternating voltage at a conducting tip of the user-held device; and
using sensing means to sense the output when the user-held device is positioned or moved such that the conducting tip is in the vicinity of the sensing means.

34. A method according to claim 33, wherein the sensing means comprises a resistive sheet and current measuring means; and sensing the output comprises using the current measuring means to measure a capacitive current flowing from the conducting tip to the resistive sheets.

35. A method according to claim 33, wherein the sensing means comprises an electric field sensing reception electrode and current sensing mean; and sensing the output comprises using the current sensing means to determine a current excited in the electric field sensing reception electrode by an electric field generated by the conducting tip.
